(19) United States
(12) Patent Application Publication
(10) Pub. No.: US 2006/0288526 A1
(43) Pub. Date: Dec. 28, 2006

(54) Caster wheel assembly

(76) Inventor: Albert W. Larson, Winnipeg (CA)

Correspondence Address: Ade & Company Inc., Henderson Highway, PO Box 28006-1795, Winniepg, MB, R2G 4E9, CA

(21) Appl. No.: 11/447,127

(22) Filed: Jun. 6, 2006

Related U.S. Application Data
(60) Provisional application No. 60/693,066, filed on Jun. 23, 2005.

(51) Int. Cl. B60B 33/00

(52) U.S. Cl. 16/44

(57) ABSTRACT

A sprung caster wheel assembly includes a base member supporting an object thereon and a swivel member mounted for rotation about a vertical swivel axis below the base member. Two spaced apart pivot arms are pivotally coupled to the swivel member for pivotal movement about a first lateral axis and rotatably support a wheel between the free ends thereof. The wheel rotates about a second lateral axis parallel to the first lateral axis and offset to one side of the vertical swivel axis. A torsion spring is helically wound about the first lateral axis and is coupled between the pivot arm and the swivel member to provide a sprung suspension to the base member supported above the wheel.

This application claims the benefit under 35 U.S.C. 119(e) of U.S. provisional application Ser. No. 60/693,066, filed Jun. 23, 2005.

### FIELD OF THE INVENTION

The present invention relates to a caster wheel assembly of the type including a base member for attachment to an object to be supported, a swivel member mounted on the base member for rotation about a vertical swivel axis, a wheel mounted on the swivel member for rotation about a horizontal axis offset to one side of the vertical swivel axis and spring suspension means between the wheel and the swivel member to allow some flexing of the wheel in a vertical direction in response to impact with uneven terrain, curbs or the like.

### BACKGROUND

Sprung caster wheel assemblies of the above type are well known and are used on many different types of equipment for supporting the equipment in movement across the ground. One particular area where castor wheels of this type are used is in relation to pallet lifting dollies. Such pallet dollies include a pair of parallel lifting bars each having a ground wheel at an outer end thereof. At an inner end of the bars is provided a main support structure with a manual control unit, the main supporting structure including a main central wheel acting as drive and steering wheel in what is essentially a three wheeled unit. In order to prevent tilting of the main unit to each side there is provided a pair of castor wheels one on each side of the main drive wheel. These castor wheels are sprung so the wheel can lift slightly to accommodate uneven terrain or impact with curbs or the like. However one prior construction is relatively complex and expensive and also is prone to damage since the main side plates supporting the wheels are not sprung and if they should impact a curb, the full impact is taken within the swivel joint often causing damage.

Conventional sprung castor wheels typically involve a spring which is mounted under tension or under compression as described in U.S. Pat. No. 6,539,578 to Guttmann et al. The orientation of the spring in this instance limits the amount of overall deflection permitted. It is common for the spring to deflect to its minimum length at which point no further suspension is provided and the castor is subject to damage upon further impact.

Other forms of suspension in a castor wheel involve the use of elastomeric materials supported under compression or torsion. One such sprung castor wheel assembly is disclosed in U.S. Pat. No. 5,448,796 to Larson. The range of deflection is sometimes limited in these types of sprung castor wheel assemblies.

U.S. Pat. Nos. 2,923,961 to Black and 800,377 to Kurtz disclose examples of torsion springs used to support a castor-like wheel. The wheel is supported by the spring itself however and accordingly the suspension is limited to light loads as heavy loads will cause deformation of the spring.

### SUMMARY OF THE INVENTION

According to one aspect of the invention there is provided a caster wheel assembly for supporting an object thereon for rolling movement along the ground, the assembly comprising:

a base member for supporting the object thereon;

a swivel member mounted on the base member for rotation about a vertical swivel axis,

a pivot arm extending longitudinally between an inner end and an outer end, the inner end being pivotally coupled to the swivel member for pivotal movement about a first lateral axis;

a wheel rotatably supported at the outer end of the pivot arm for rotation about a second lateral axis parallel to the first lateral axis and offset to one side of the vertical swivel axis; and

spring suspension between the pivot arm and the swivel member to allow some flexing of the wheel in a vertical direction, the spring suspension comprising a torsion spring helically wound about a respective spring axis and coupled between the pivot arm and the swivel member such that the spring axis lies parallel to the first and second lateral axes.

Use of a pivot arm coupled between the wheel and the swivel member permits motion of the wheel deflection relative to the swivel member to be controlled along the pivoting path of the pivot arm. A torsion spring can then be coupled between the pivot and the swivel member to provide a maximum range of deflection, while not relying on the torsion spring itself to carry the wheel or constrain its movement of deflection relative to the swivel member. A durable castor wheel assembly results which can be readily manufactured at low cost while accommodating large weights supported thereon in industrial applications.

The first lateral axis may be fixed in orientation and position in relation to the swivel member with the torsion spring being coaxial with the first lateral axis.

When the pivot arm is pivotally supported about a pivot shaft, the torsion spring may be wound about the pivot shaft.

The swivel member may comprise a rigid tubular housing which surrounds the torsion spring and which is enclosed at opposing ends by a pair of pivot arms respectively.

Preferably, both a biasing force applied by the torsion spring and connection between the torsion spring and the pivot arm is adjustable.

The pivot arms may extend at a downward and outward inclination from the first lateral axis in a relaxed condition of the torsion spring.

When there is provided a pair of pivot arms pivotally coupled to opposing ends of the swivel member for pivotal movement about the first lateral axis, the wheel is preferably rotatably supported between the outer ends of the pivot arms for rotation about the second laterally axis.

The pivot arms are preferably pivotally supported about a common shaft.

The torsion spring may be coupled at opposing ends to the pair of pivot arms respectively and centrally anchored in fixed relation to the swivel member.

One embodiment of the invention will now be described in conjunction with the accompanying drawings in which:

### BRIEF DESCRIPTION OF THE DRAWINGS

FIG. 1 is a perspective view of the castor wheel assembly.

FIG. 2 is a partly sectional top plan view of the assembly according to FIG. 1.

FIG. 3 is a side elevational view of the assembly.

FIG. 4 is a side elevational view of the swivel member with the pivot arms removed therefrom.

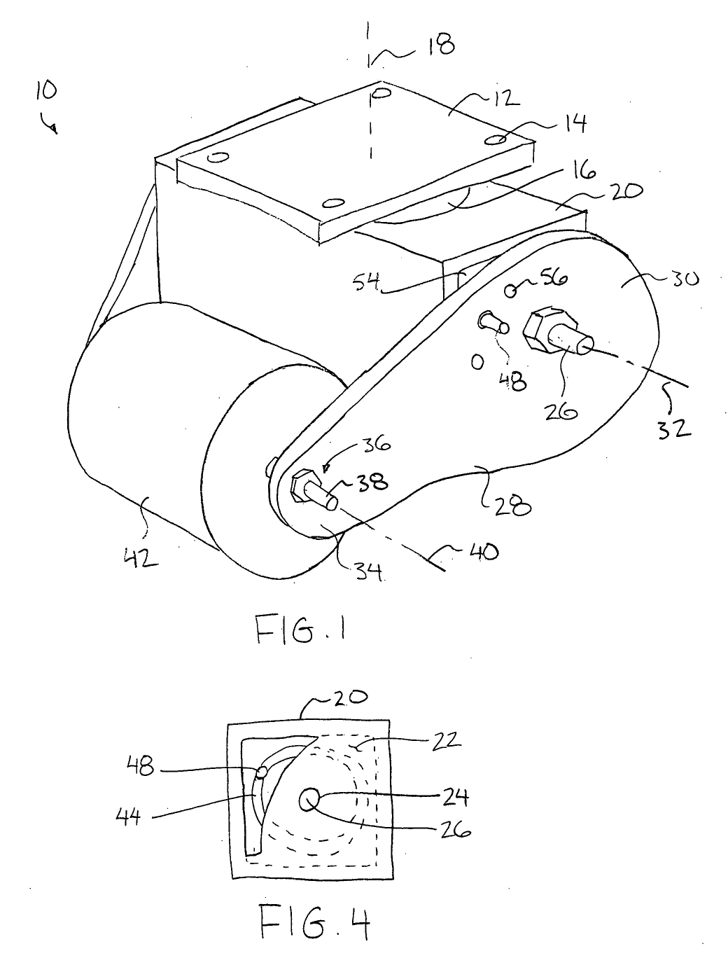

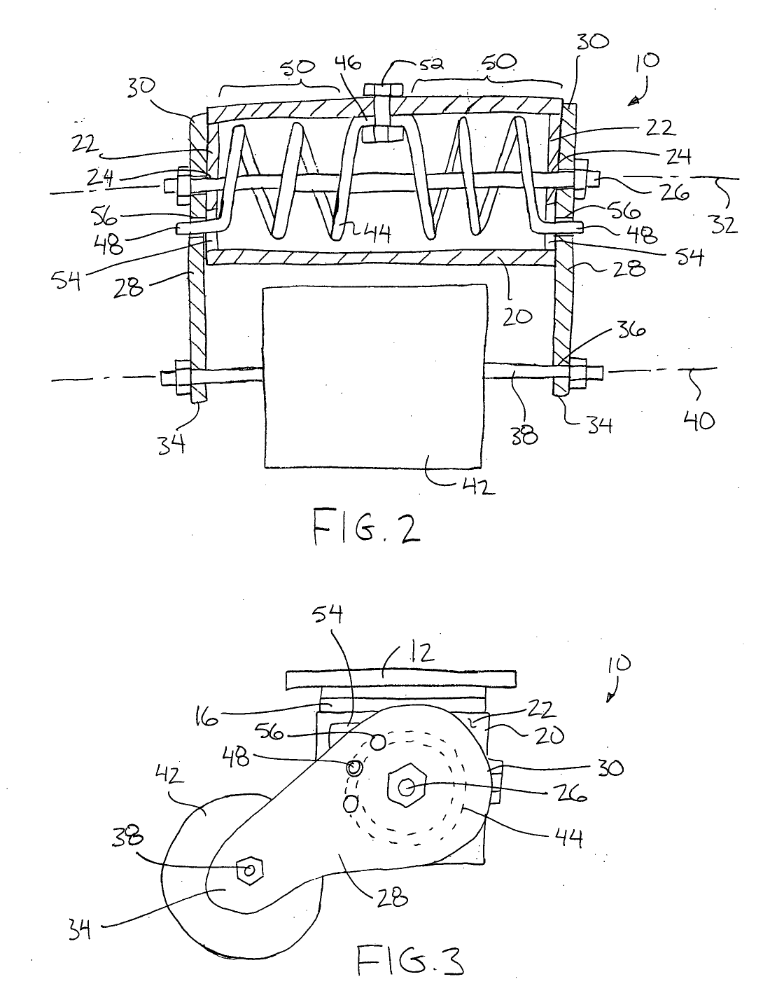

In the drawings like characters of reference indicate corresponding parts in the different figures.

### DETAILED DESCRIPTION

Referring to the accompanying Figures there is illustrated a castor wheel assembly generally indicated by reference numeral 10. The assembly 10 is particularly suited for supporting an object thereon for rolling movement along the ground.

The assembly 10 generally comprises a base member 12 in the form of a mounting plate having generally horizontal top and bottom sides. The object to be supported is received on the top side of the base member and connected using suitable fasteners through mounting apertures 14 in the base member.

A swivel member 16 is pivotally connected the base member 12 therebelow for relative pivotal movement about a vertical swivel axis 18. The swivel axis 18 is perpendicular to the top mounting surface of the base member 12.

The swivel member includes a housing 20 comprises a hollow rigid tube which is square in cross section. A longitudinal direction of the housing 20 which spans between the open ends 22 thereof is oriented perpendicularly to the vertical swivel axis 18.

Rigid end plates 22 partially span each end of the housing 20 to partially enclose the open ends thereof. The end plates each span a central portion of the open end for locating a central mounting hole 24 therein. The central holes 24 at opposing ends of the housing are coaxial with one another for receiving a horizontal shaft 26 extending longitudinally therethrough perpendicular to the vertical axis.

Two pivot arms 28 are pivotally coupled at opposing ends of the shaft 26. Each pivot arm comprises a vertical plate extending in a longitudinal direction between an inner end 30 pivotally mounted on the shaft 26 and a free outer end spaced radially outwardly from the shaft. The plates forming the pivot arms 28 are oriented parallel and spaced apart from one another at opposing ends of the housing 20. The shaft 26 defines a first lateral axis 32 which comprises the pivot axis of the pivot arms 28. The pivot arms 28 are abutted at opposing ends of the housing to enclose the ends by overlapping a portion of ends of the housing 20 which are not already overlapped by the end plates 22 thereof.

Mounting apertures 36 are provided in the outer ends 34 of each pivot arm for receiving a common wheel axle 38 spanning thereacross. The wheel axle 38 defines a second lateral axis 40 spanning horizontally between the plates parallel to the first lateral axis 32. A wheel 42 is mounted about the axle 38 for rotation about the second lateral axis 40 using bearings for free rotation of the wheel.

A torsion spring 44 is mounted within the housing 20. The spring 44 is enclosed within the hollow interior of the housing and spans between the pivot arms 28 at opposing ends of the housing. The spring is formed of spring steel which is helically wound from a central U-shaped portion 46 in opposing lateral directions to respective outer free ends 28 which connect to the pivot arms 28 respectively. The spring 44 is wound in a common rotational direction from the center outward to the opposing free ends 48 so as to effectively define two separate spring portions 50 joined with one another at the center U-shaped portion 46. A common spring axis of the two spring portions is coincident with the first lateral axis 32 because the torsion spring lies concentrically with the shaft 26. In the relaxed condition of the spring, the overall diameter of the spring is near but slightly less than the interior diameter of the tubular housing 20 which receives the spring therein. A central anchor bolt 52 couples the central U-shaped portion 46 of the torsion spring to one of the side walls of the housing, centrally between opposed ends thereof.

The free ends 48 of the spring 44 are bent to project parallel to the spring axis beyond the ends of the housing through the portion of the ends not enclosed by the end plates 22. A generally arc shaped slot is thus defined at the end plates 22 spaced radially outwardly from the shaft 26 a distance which is approximately the radius of the spring 44 for receiving the free ends 44 therethrough.

Cooperating apertures 56 are provided in the plates forming each of the pivot arms 28 for receiving the free ends 48 of the spring therein respectively. The apertures are dimensioned to snugly receive the free ends of the spring therein with a close tolerance therebetween. Plural apertures 56 are provided in each pivot arm 28 at circumferentially spaced positions about the first lateral axis 32 so that mounting of the free ends 48 in each aperture corresponds to a different inclination of the pivot plates in a relaxed condition of the spring which in turn relates to a different height of the wheel relative to the base in a relaxed condition of the spring. This permits some adjustment for different size loads being handled by the castor wheel assembly as adjusting the wheel to a greater height between the wheel and base member in the relaxed condition permits greater deflection of the spring which in turn permits more weight to be carried. The slot 54 formed in the end plates overlaps all of the apertures 56 formed in the pivot arms 28 as well as accommodating and desirable deflection of the pivot arms 28 pivoted about the horizontal shaft 26.

When the spring 44 is relaxed, the pivot arms extend downwardly at an outward incline from the first lateral axis 32 to the second lateral axis spaced laterally and downwardly therefrom. As weight is applied to the castor wheel assembly, the spring is flexed and the wheel along with the outer ends of the pivot arms is deflected upwardly so that the pivot arms lie closer to horizontal with the second lateral axis nearer in elevation to the first lateral axis. The inclination of the pivot arms in the relaxed position of the spring before loading will vary depending upon which of the apertures 56 are selected upon assembly.

The apertures 56 in the pivot arms 28 are always selected in corresponding pairs so that the pivot arms have a similar inclination with the second lateral axis of the wheel being parallel to the first lateral axis of the shaft 26. Opposing ends of the shaft 26 are threaded for receiving a nut thereon which secures the plates of the pivot arms 28 onto the shaft. Selection of the apertures 56 which receive the free ends of the spring therein is accomplished by removing the nuts so that the plates can be axially displaced outwardly to release the free ends 48 of the spring from the selected apertures prior to insertion into new apertures when reassembling the pivot arms onto the opposing ends of the shafts.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A caster wheel assembly for supporting an object thereon for rolling movement along the ground, the assembly comprising:
a base member for supporting the object thereon;
a swivel member mounted on the base member for rotation about a vertical swivel axis,
a pivot arm extending longitudinally between an inner end and an outer end, the inner end being pivotally coupled to the swivel member for pivotal movement about a first lateral axis;
a wheel rotatably supported at the outer end of the pivot arm for rotation about a second lateral axis parallel to the first lateral axis and offset to one side of the vertical swivel axis; and
spring suspension between the pivot arm and the swivel member to allow some flexing of the wheel in a vertical direction, the spring suspension comprising a torsion spring helically wound about a respective spring axis and coupled between the pivot arm and the swivel member such that the spring axis lies parallel to the first and second lateral axes.

2. The assembly according to claim 1 wherein the first lateral axis is fixed in relation to the swivel member.

3. The assembly according to claim 1 wherein the torsion spring is coaxial with the first lateral axis.

4. The assembly according to claim 1 wherein the pivot arm is pivotally supported about a pivot shaft and wherein the torsion spring is wound about the pivot shaft.

5. The assembly according to claim 1 wherein the swivel member comprises a tubular housing which surrounds the torsion spring.

6. The assembly according to claim 5 wherein there is provided a pair of pivot arms enclosing opposing ends of the tubular housing.

7. The assembly according to claim 1 wherein a biasing force applied by the torsion spring is adjustable.

8. The assembly according to claim 7 wherein connection between the torsion spring and the pivot arm is adjustable.

9. The assembly according to claim 1 wherein the pivot arm extends at a downward and outward inclination from the first lateral axis in a relaxed condition of the torsion spring.

10. The assembly according to claim 1 wherein there is provided a pair of pivot arms pivotally coupled to opposing ends of the swivel member for pivotal movement about the first lateral axis and wherein the wheel is rotatably supported between the outer ends of the pivot arms for rotation about the second laterally axis.

11. The assembly according to claim 10 wherein the pivot arms are pivotally supported about a common shaft.

12. The assembly according to claim 10 wherein the torsion spring is coupled at opposing ends to the pair of pivot arms respectively.

13. The assembly according to claim 12 wherein the torsion spring is centrally anchored to the swivel member.
